(19) United States
(12) Patent Application Publication
(10) Pub. No.: US 2025/0054467 A1
(43) Pub. Date: Feb. 13, 2025

(54) CONFIGURABLE FOOT PEDAL SUPPORT ASSEMBLY

(71) Applicant: David R. Tweedie, Los Angeles, CA (US)

(72) Inventors: David R. Tweedie, Los Angeles, CA (US); Daniel Reetz, Los Angeles, CA (US); Mark Monson, Union Grove, WI (US)

(21) Appl. No.: 18/796,704

(22) Filed: Aug. 7, 2024

Related U.S. Application Data
(60) Provisional application No. 63/531,692, filed on Aug. 9, 2023.

(51) Int. Cl. G10C 3/26

(52) U.S. Cl. CPC G10C 3/26

(57) ABSTRACT

A foot pedal support assembly is provided for musical instrument stands such as keyboard stands. The foot pedal support assembly connects to the musical instrument stand and provides mounting for a foot pedal such as a musical instrument effects pedal, sustain pedal, or the like. The foot pedal support assembly is adjustable to accommodate different musical instrument stands with different dimensions and may be securely clamped to the musical instrument stand and unclamped from the musical instrument stand with integrated clamps that accommodate different sizes of musical instrument stands.

### CROSS-REFERENCE TO RELATED APPLICATIONS

This application claims the benefit of and priority to U.S. Provisional Patent Application No. 63/531,692 filed on Aug. 9, 2023 and entitled “CONFIGURABLE FOOT PEDAL SUPPORT ASSEMBLY.” The disclosure of the foregoing application is incorporated herein by reference in its entirety, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to musical instruments, and in particular to support structures for musical instruments.

### BACKGROUND

Conventional supports for certain musical instruments, such as synthesizers, keyboards, and the like, are known as “square stands.” These may have a shape such as an X-shape, Z-shape, U-shape, or other suitable shape, and may be adjustable to provide a desired height of support. Foot-operated controllers (such as sustain, soft, or sostenuto pedals, foot switches, foot-operated effects boxes, and/or the like) are typically placed on the floor in the area between the lower feet of the stand. However, the foot controllers often move or slide, especially during high-energy or particularly expressive musical performances, which can lead to missed inputs or other performance errors or difficulties. Accordingly, improved approaches for positioning and securing foot controllers remain desirable.

### SUMMARY

A clamping mechanism is disclosed. The mechanism may include a clamp finger. The mechanism may include a knob. The clamp finger may be coupled to a main body and pivotable with respect thereto about a pin. The clamp finger may have a conically tapered depression. The knob may be engaged with the clamp finger via a bolt. The knob may include rounded lower surface. The knob may be rotated about the bolt. In connection with the rotating, the rounded lower surface of the knob engages at least a portion of the conically tapered depression to cause the clamp finger to pivot about the pin in a first direction to exert a clamping force.

The clamping mechanism may have one or more other aspects as well. For instance, the clamping mechanism may include a torsion spring disposed about the pin and resisting the pivoting in the first direction. The clamp finger may bound a notched portion of the main body configured to receive a foot tube of a keyboard stand and may exert the clamping force against the foot tube to retain the main body in contact with the foot tube.

A foot pedal support assembly is provided. The assembly may include a telescoping main body. The assembly may include a slider and a support plate coupled to the main body and configured to support a foot pedal. The assembly may include a pair of clamps coupled to the main body. Each of the pair of clamps may be configured to releasably couple to a foot tube of a key board stand.

In various embodiments, the foot pedal support assembly includes one or more further aspects. The telescoping main body may include an inner body and an outer body. The inner body may be telescopically receivable into the outer body. A first clamp of the pair of clamps may be coupled to an end of the inner body. A second clamp of the pair of clamps may be coupled to an end of the outer body. The first clamp and second clamp may be positionable at different distances away from each other by telescoping the main body.

The pair of clamps may include a first clamp and a second clamp. The first clamp and second clamp may be spaced apart along the main body. The first clamp may include a clamp finger coupled to the main body and pivotable with respect thereto about a pin. The clamp finger may include a conically tapered depression. The first clamp may include a knob engaged with the clamp finger via a bolt. The knob may include a rounded lower surface. The rounded lower surface of the knob may engage at least a portion of the conically tapered depression to cause the clamp finger to pivot about the pin in a first direction to exert a clamping force.

The clamp finger may abut the foot tube of the keyboard stand and may exert the clamping force against the foot tube. The second clamp may be identical to the first clamp and disposed at an opposite end of the main body relative to the first clamp.

In various instances, the pair of clamps includes a first clamp and a second clamp wherein the first clamp and second clamp are spaced apart along the main body. The first clamp may include a first clamp finger coupled to the main body and pivotable with respect thereto about a first pin. The first clamp finger may include a first conically tapered depression. The first clamp may include a first knob engaged with the first clamp finger via a first bolt, wherein the first knob has a first rounded lower surface. The first rounded lower surface of the first knob may engage at least a portion of the first conically tapered depression to cause the first clamp finger to pivot about the first pin in a first direction to exert a clamping force. The second clamp may include a second clamp finger coupled to the main body and pivotable with respect thereto about a second pin. The second clamp finger may include a second conically tapered depression. The second clamp may include a second knob engaged with the second clamp finger via a second bolt. The second knob may include a second rounded lower surface. The second rounded lower surface of the second knob may engage at least a portion of the second conically tapered depression to cause the second clamp finger to pivot about the second pin in a second direction to exert a clamping force.

In various instances, the telescoping main body includes an inner body and an outer body. The inner body is telescopically receivable into the outer body. A first clamp of the pair of clamps is coupled to an end of the inner body. A second clamp of the pair of clamps is coupled to an end of the outer body.

A pedal support plate may be attachable to the outer body of the main body along a length of the main body between the first clamp and the second clamp. The pedal support plate may extend perpendicular to the length of the main body. A foot pedal may be attached to the pedal support plate.

A bracket may be attachable to the outer body of the main body along a length of the main body between the first clamp and the second clamp. The bracket may slidably attach to a pedal support plate extending away from the main body perpendicularly to the length of the main body. The pedal support plate may slide along the bracket in a direction normal to a surface of the outer body of the main body. The bracket may be slidable along the length of the main body. The bracket may have an adjustment flange extending outwardly from the bracket. The bracket may bend in response to application of an external force on the adjustment flange to selectably loosen attachment of the bracket to the main body.

A method is provided. The method may be for securing a foot pedal for a musical instrument. The method may include providing a stand for the musical instrument, the stand having a first foot tube and a second foot tube separated by a distance. The method may include adjusting a width of a foot pedal assembly to correspond to the distance. The method may include releasably coupling the foot pedal support assembly to the first foot tube via a first clamp. The method may include releasably coupling the foot pedal support assembly to the second foot tube via a second clamp. The method may include releasably coupling the foot pedal to the foot pedal support assembly.

### BRIEF DESCRIPTION OF THE DRAWINGS

With reference to the following description, appended claims, and accompanying drawings:

FIG. 1A illustrates a foot pedal support assembly attached to a keyboard stand in accordance with an exemplary embodiment;

FIG. 1B illustrates a perspective view of an exemplary foot pedal support assembly in accordance with an exemplary embodiment;

FIG. 2 illustrates an exploded view of an exemplary foot pedal support assembly in accordance with an exemplary embodiment;

FIG. 3 illustrates a perspective view of a notched end portion in accordance with an exemplary embodiment;

FIG. 4 illustrates a perspective view of a pedal support slider in accordance with an exemplary embodiment;

FIG. 5 illustrates a perspective view of a pedal support plate in accordance with an exemplary embodiment;

FIG. 6 illustrates a perspective view of a lever finger in accordance with an exemplary embodiment;

FIG. 7 illustrates a sectional view of a portion of an exemplary foot pedal support assembly in accordance with an exemplary embodiment, illustrating adjustable clamping capabilities;

FIG. 8 illustrates the sectional view of a portion of an exemplary foot pedal support assembly of FIG. 7, showing the lever finger partially rotated to clamp a foot tube, in accordance with an exemplary embodiment;

FIG. 9 illustrates a sectional perspective view of a portion of an exemplary foot pedal support assembly in accordance with an exemplary embodiment;

FIG. 10 illustrates a sectional view of a body portion of an exemplary foot pedal support assembly in accordance with an exemplary embodiment; and

FIG. 11 illustrates a method of coupling a pedal to a musical instrument stand in accordance with an exemplary embodiment.

Other apparatus, methods, features, and advantages of the present disclosure will be apparent to one skilled in the art upon examination of the following figures and detailed description. Component parts shown in the drawings are not necessarily to scale and may be exaggerated to better illustrate the important features of the present disclosure.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims.

For the sake of brevity, conventional techniques for mechanical fabrication, forming, and coupling, as well as conventional techniques for fastening, sliding, retaining, clamping, and/or the like may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical system, for example a foot pedal support assembly for use with a keyboard stand.

Various shortcomings of prior foot pedal systems can be addressed by utilizing foot pedal support assemblies configured in accordance with principles of the present disclosure. For example, a foot pedal support assembly as disclosed herein has an adjustable width, permitting use with a variety of square stands (for example, X-stands, Z-stands, U-stands, T-stands, and/or the like) and positions thereof. Moreover, a foot pedal support assembly in accordance with principles of the present disclosure may be configured with any suitable components, structures, and/or elements in order to provide desired physical properties and/or configurability. Additionally, in accordance with principles of the present disclosure, an exemplary system may be configured to retain and support multiple foot pedals across a range of spacings between the foot bars of a key board stand.

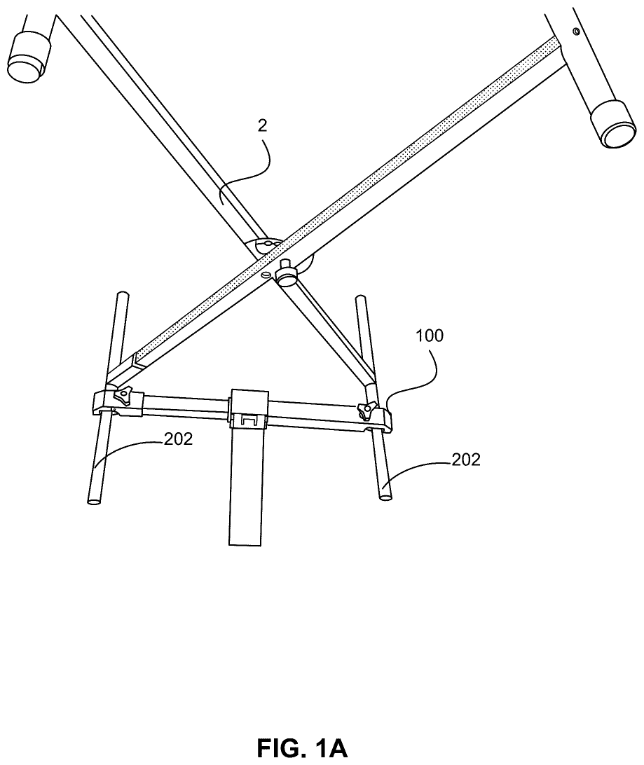

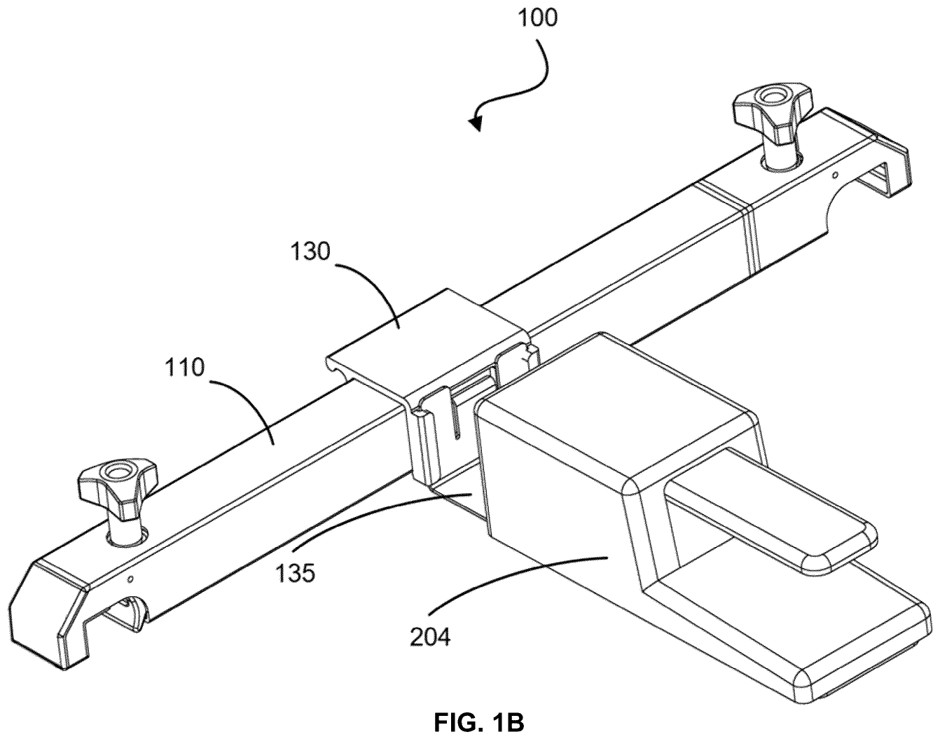

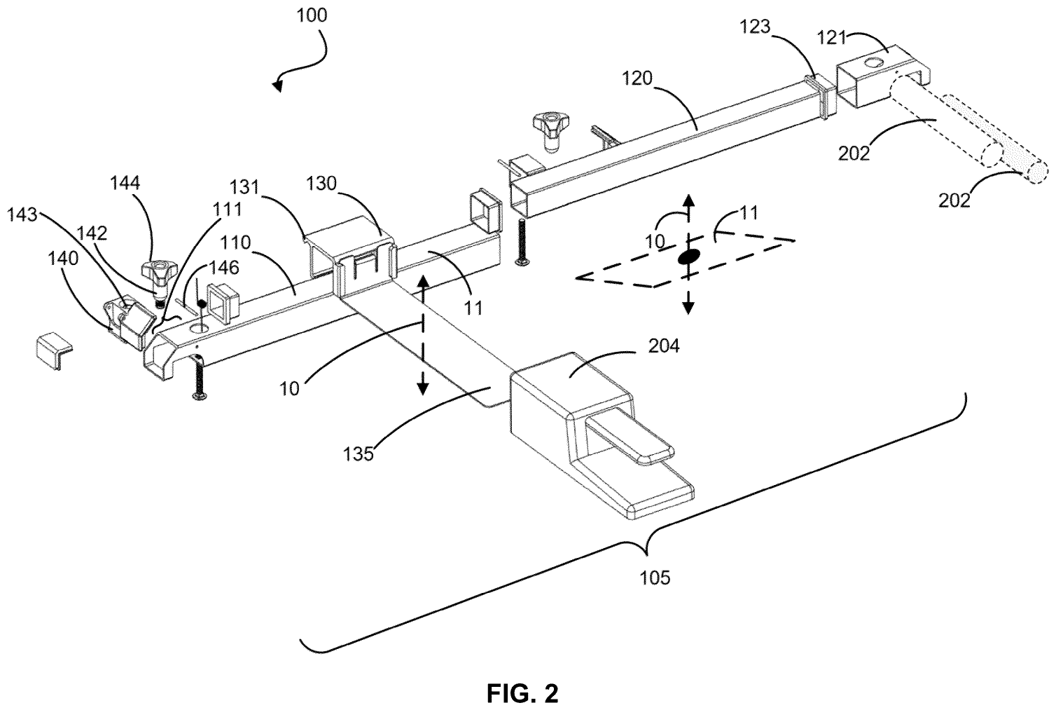

In accordance with an exemplary embodiment, and with reference to FIGS. 1A, 1B, and 2, a configurable foot pedal support assembly (FPSA) 100 generally comprises a main body 105 comprising an inner body 120 telescopically engaged with an outer body 110. Bracket 130 is movably coupled to outer body 110 such that bracket 130 is moveable lengthwise along outer body 110 to any position desired by a user. Bracket 130 is coupled to pedal support plate 135. The pedal support plate 135 may support a foot pedal 204.

FPSA 100 couples to a keyboard stand 2 to provide a stable, adjustable mechanism to secure one or more foot pedals with respect thereto. In this manner, a user of FPSA 100 can utilize a foot pedal with a higher degree of reliability, consistency, and/or accuracy.

Main body 105 is configured with or coupled to portions on either end thereof that are sized to at least partially receive a portion of a keyboard stand foot tube. For example, main body 105 may comprise a notched or cut-out portion 111 in outer body 110. Moreover, inner body 120 may comprise and/or be coupled to a notched end portion 121. In this manner, FPSA 100 may be placed onto the foot tubes of a keyboard stand from above and be affixable thereto. FPSA 100 is usable with keyboard stand foot tubes 202 of varying dimensions and configurations. For example, FIG. 2 shows two different keyboard stand foot tubes 202 adjacent to a notched end portion 121, either of which may be used with the FPSA 100. For example circular foot tubes having a diameter of between about 0.75 inches and about 2 inches, or between about 19 mm and about 50 mm may be used. Moreover, FPSA 100 is usable with keyboard stand foot tubes having non-circular cross-sections, for example an ovoid, square, rectangular, or other cross-section.

Outer body 110 comprises a durable material such as aluminum, steel, high-density plastic, or other suitable material. In an exemplary embodiment, outer body 110 comprises mild steel (A36) or similar low carbon steel. Outer body 110 corresponds telescopically with inner body 120 such that inner body 120 is slideable at least partially within and/or into outer body 110. In various exemplary embodiments, outer body 110 is generally tubular with a square, rectangular, or similar shape.

Inner body 120 comprises a durable material such as aluminum, steel, high-density plastic, or other suitable material. In an exemplary embodiment, inner body 120 comprises mild steel (A36) or similar low carbon steel. Inner body 120 may comprise the same material as outer body 110; alternatively, inner body 120 and outer body 110 may differ in materials from one another. Outer body 110 and inner body 120 may be lockingly telescoping with respect to one another (for example, via a series of notches, stops, insertable pins combined with corresponding holes, or the like); alternatively, they may be continuously and/or freely slidable with respect to one another. It will be appreciated that FPSA 100 may comprise two telescoping elements, for example as disclosed above; moreover, FPSA 100 may comprise three telescoping elements, for example in order to accommodate a wider distance between feet of a keyboard stand.

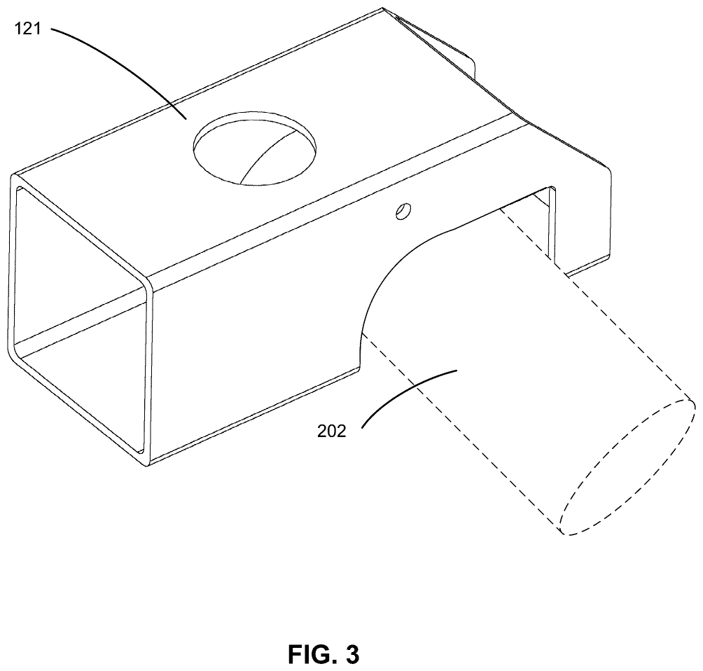

Referring to FIGS. 2 and 3, FPSA 100 may comprise a notched end portion 121. Notched end portion 121 may at least partially receive an end portion 123 of inner body 120 and thereby be coupled thereto. In this manner, FPSA 100 may present an increased amount of suitable surface for sliding the bracket 130 therealong or coupling the bracket 130 thereto, regardless of how “expanded” or “telescoped” a particular configuration of FPSA 100 may be when coupled to a particular keyboard stand. In this manner, FPSA 100 may be adjustably lengthened or shortened to align the notched end portion 121 and the cut-out portion 111 (FIG. 1B) with the foot tubes 202 of a keyboard stand 2.

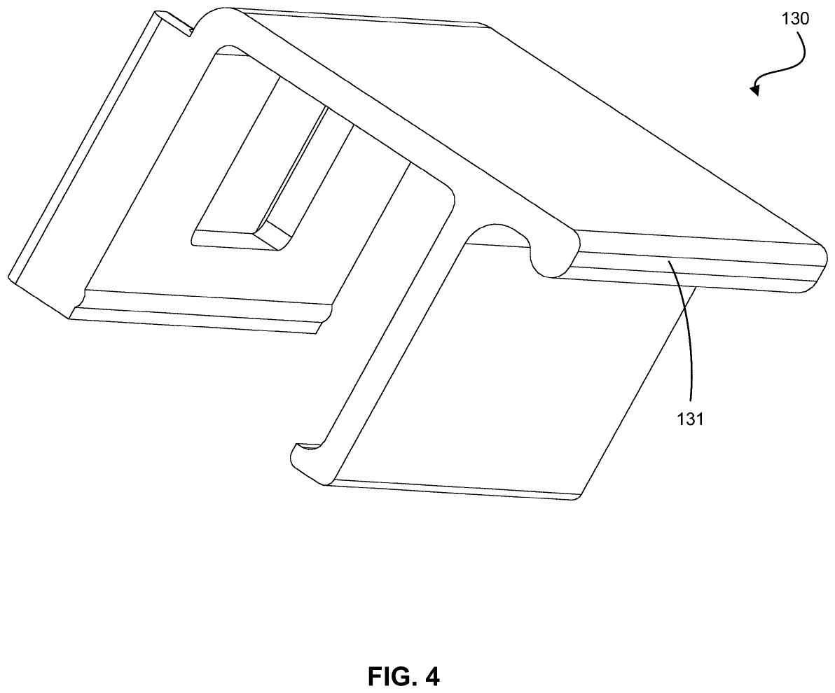

With reference now to FIGS. 2 and 4, bracket 130 comprises a durable material such as high-density plastic or other suitable material. In an exemplary embodiment, bracket 130 comprises ABS plastic. Bracket 130 may be formed by any suitable process. such as additive manufacturing, injection molding, CNC machining, and/or the like. Bracket 130 may be formed from sheet metal, such as by bending and/or cutting sheet into a shape of bracket. Bracket 130 is releasably coupled to and slidable along main body 105 to allow positioning of a foot pedal at a desired location. Bracket 130 may be configured to receive at least a portion of outer body 110 and to be retained thereto, for example via a friction fit, snap fit, retaining lip, and/or the like. In various embodiments, bracket 130 comprises an adjustment flange 131 which, when pulled on by a user, loosens the grip of bracket 130 on outer body 110 and allows bracket 130 to be repositioned with respect thereto or entirely decoupled therefrom. When FPSA 100 is coupled to a keyboard stand, adjustment flange 131 is easily accessible in the vertical direction for a user, permitting unobstructed access for adjustment as desired. Bracket 130 is coupled to pedal support plate 135.

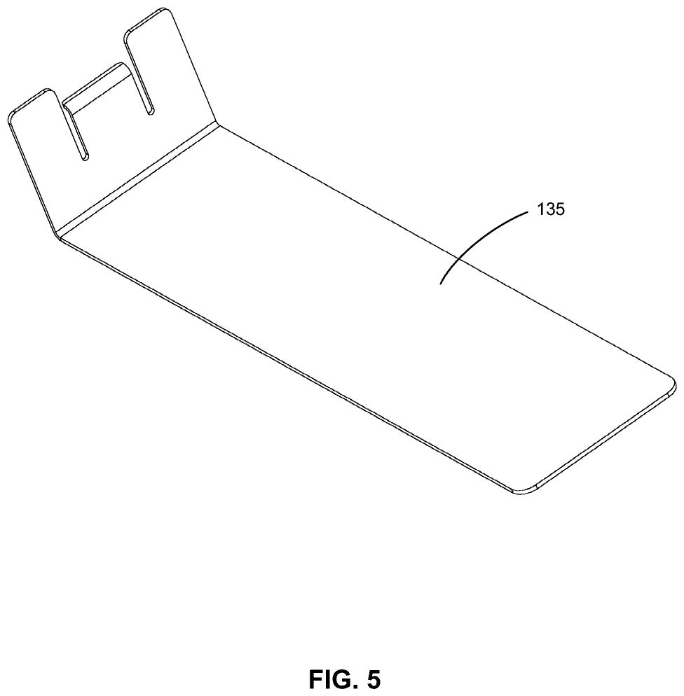

With reference now to FIGS. 2 and 5, pedal support plate 135 comprises a durable material such as aluminum, steel, high-density plastic, or other suitable material. In an exemplary embodiment, pedal support plate 135 comprises brake bent or stamped mild steel (A36). Pedal support plate 135 is slidingly coupled to bracket 130 as shown in FIG. 2, to permit pedal support plate 135 to move up and down in a generally vertical direction 10. Vertical direction 10 may be a direction normal to a surface 11 of the outer body 110 of the main body 105. In this manner, pedal support plate 135 may be configured to be in stable contact with the ground, floor, stage, or other surface beneath FPSA 100, regardless of the thickness of the keyboard stand feet or end caps thereon, regardless of the type of surface (e.g., hardwood, carpet, tile, concrete, etc.) In this manner, pedal support plate 135 provides a stable surface for coupling a foot pedal 204 (FIG. 2) thereto. A foot pedal 204 (FIG. 2) may be removably or fixedly coupled to pedal support plate 135 in any suitable manner, for example via hook and loop fasteners, double sided adhesive tape, clamps, glues, fasteners, and/or the like.

It will be appreciated that multiple brackets 130 and corresponding pedal support plates 135 may be coupled to main body 105, in order to permit use of two foot pedals, three foot pedals, four foot pedals, and/or an even larger number of foot pedals (for example, depending at least in part on widths thereof and the distance between foot tubes of a keyboard stand).

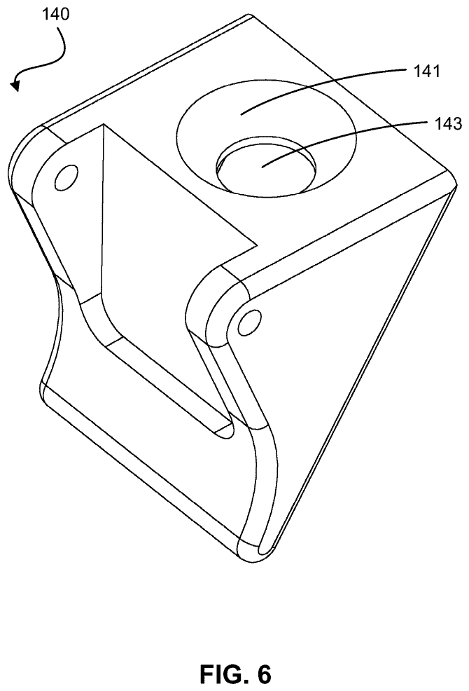

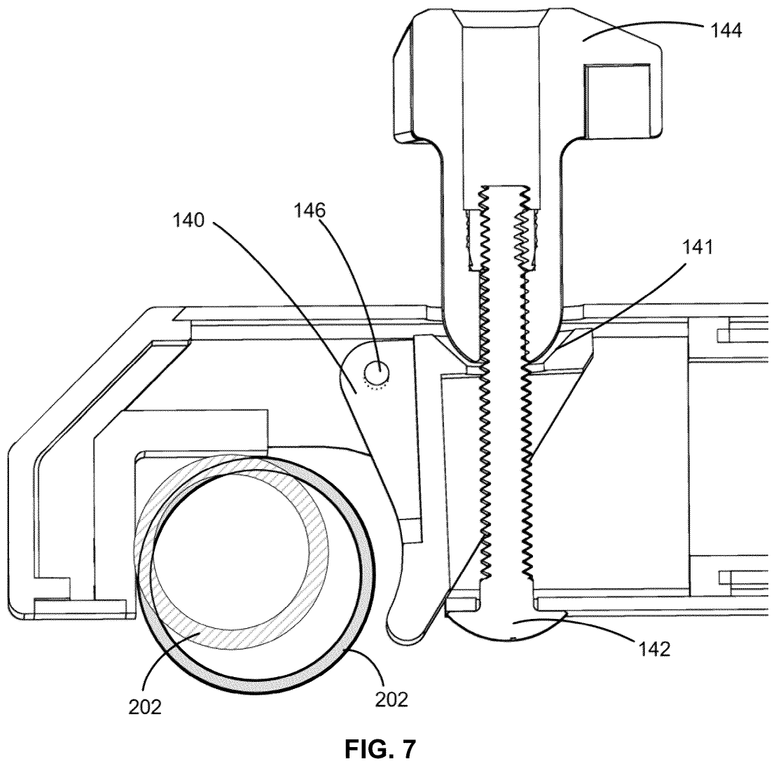

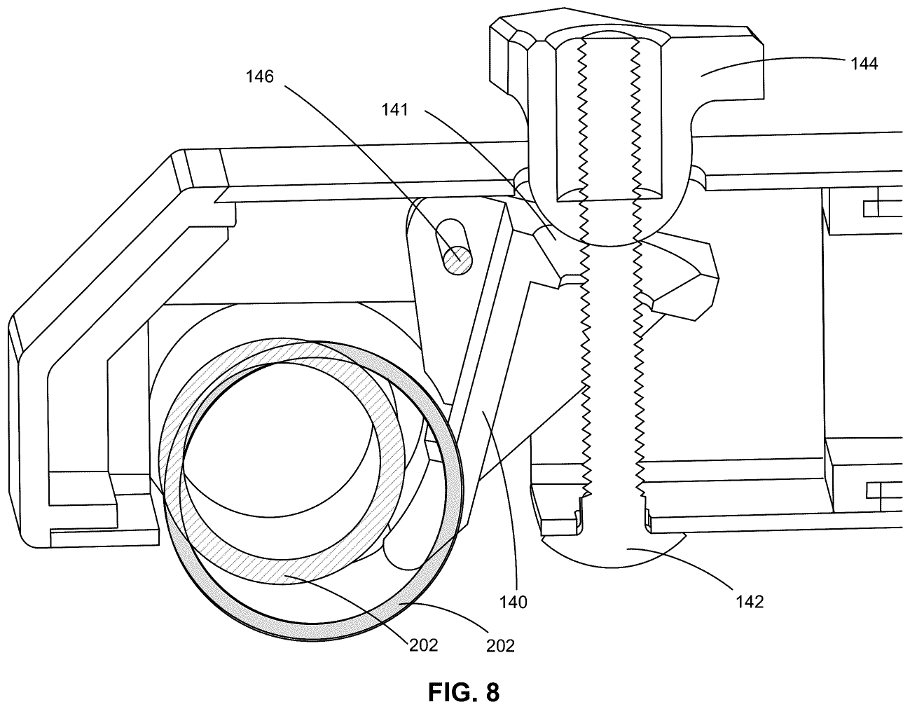

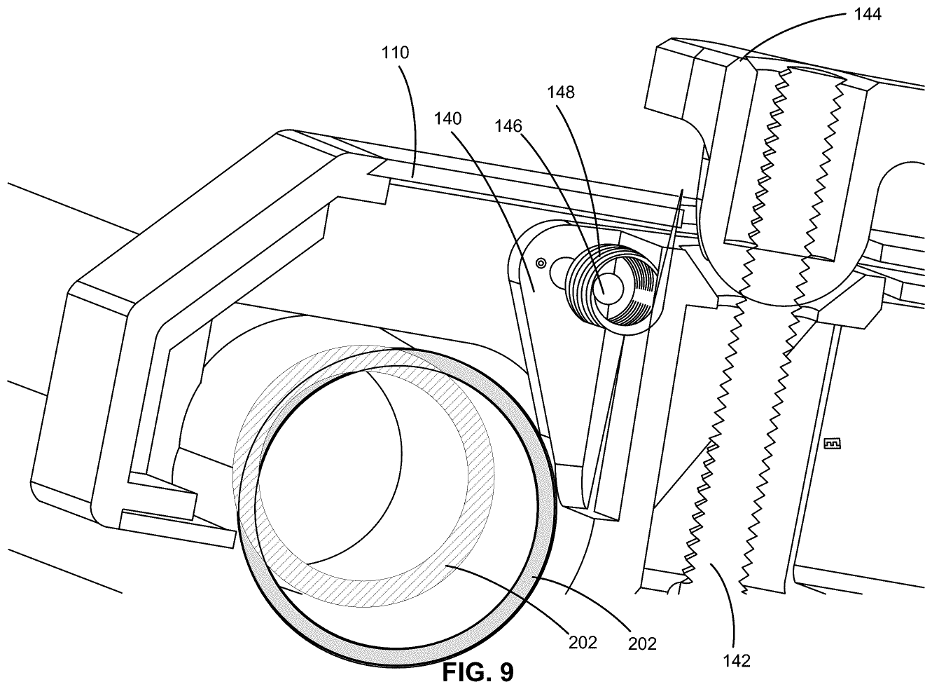

With reference now to FIGS. 2 and 6-9, in various exemplary embodiments the FPSA 100 comprises a pair of adjustable clamping mechanisms to secure FPSA 100 to the foot tubes of a keyboard stand. It will be appreciated that FPSA 100 allows for coupling to foot tubes having various spacings therebetween, for example between about 17 inches (about 43 cm) and about 32 inches (about 81 cm) in embodiments having two telescoping elements, or between about 17 inches (about 43 cm) and about 36 inches (about 91 cm) in embodiments having three telescoping elements.

In an exemplary embodiment, FPSA 100 comprises a clamp finger 140 pivotable about a pin 146. Clamp finger 140 may comprise any suitable durable material, for example a die cast alloy of aluminum, magnesium, and/or zinc. In various exemplary embodiments, clamp finger 140 comprises a generally curved face so as to be suitable to engage a variety of sizes of foot tube.

Clamp finger 140 is configured with a hole 143 therethrough to accept bolt 142. Clamp finger 140 additionally comprises a depression 141 that is generally conically tapered and that is about the hole 143. In various exemplary embodiments, the depression 141 having the conical taper tapers with an angle of between about 60 degrees and about 120 degrees. The diameter of the hole 143 is greater than the diameter of bolt 142 (for example, the hole 143 may have a diameter of 12 mm and bolt 142 may have a diameter of 6 mm). In various exemplary embodiments, the hole 143 has a clearance of between about 2 mm and about 4 mm around bolt 142 in all directions. In this manner, bolt 142 may have sufficient clearance to continue to pass unobstructed through the hole 143 as clamp finger 140 rotates about pin 146 to engage a foot tube 202 of a keyboard stand. For instance, FIGS. 2, 7, 8, and 9 are shown with two different foot tubes 202 superimposed in the images to illustrate the operability of the clamp finger 140 with foot tubes 202 of different sizes. One may also appreciate that the clamp finger 140 and related structure may be installed in the notched end portion 121, though these components are omitted in FIG. 2 for ease of viewing.

Bolt 142 is coupled to knob 144. As knob 144 is rotated with respect to bolt 142 to bring the knob 144 “downward” (i.e., a more tightened direction, typically clockwise), the rounded lower surface thereof engages with the conical surface of depression 141 of clamp finger 140, urging clamp finger 140 to rotate about pin 146 and thus engage with and retain a foot tube 202 of a keyboard stand. As clamp finger 140 rotates, the area where the lower portion of knob 144 contacts the depression 141 changes due to the change in angles between the respective parts, allowing smooth and continuous clamping pressure to be applied. Specifically, tightening the knob 144 results in increased contact with depression 141 generally on the side thereof positioned toward the foot tube 202 (and consequently, reduced and eventually limited or no contact on the side thereof disposed away from the foot tube 202). Knob 144 may be rotated until a desired amount of retaining pressure between clamp finger 140 and the foot tube 202 is achieved.

Conversely, as knob 144 is rotated with respect to bolt 142 to bring the knob 144 “upward” (i.e., a loosened direction, typically counterclockwise), clamp finger 140 is permitted to rotate away from the foot tube 202 and eventually release it. An opening or releasing force for clamp finger 140 may be provided by a torsion spring 148 disposed about pin 146.

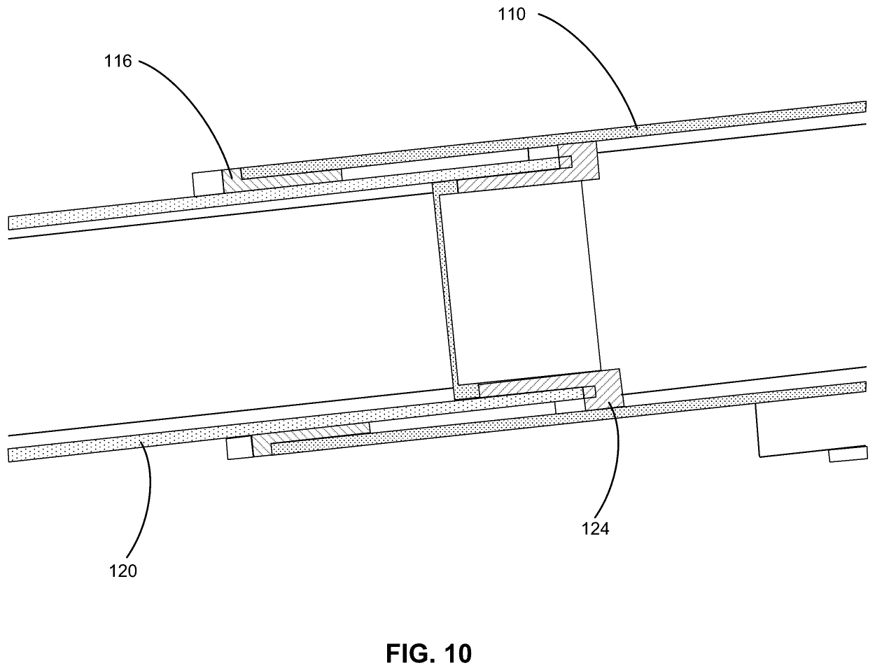

Turning now to FIG. 10, in various embodiments the inner body 120 and outer body 110 are smoothly slidable with respect to one another, and eventually retained together at a point of maximum extension, via an outer body cap 116 that may be generally ring-shaped and a similar inner body cap 124. These caps may be formed of a durable material having a desired density and/or frictional coefficient, for example high-density polyethylene (HDPE), nylon (PA6), or the like. As seen in FIG. 10, inner body cap 124 and outer body cap 116 provide guidance and support as inner body 120 and outer body 110 slide telescopically with respect to one another. As main body 105 reaches the point of maximum telescopic extension, inner body cap 124 and outer body cap 116 come into contact with one another and prevent further telescopic expansion.

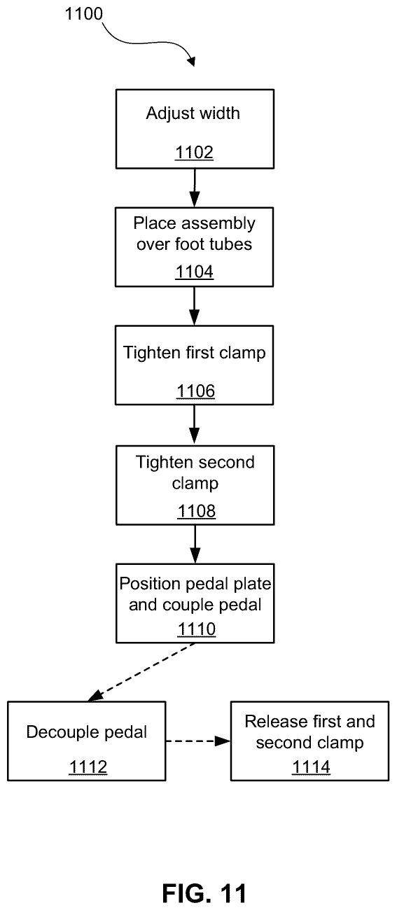

With reference now to FIG. 11, in various exemplary embodiments a method 1100 of coupling a foot pedal to a keyboard stand comprises adjusting a width of a foot pedal support assembly (block 1102). The method further comprises placing the foot pedal support assembly at least partially over a first foot tube and a second foot tube of the keyboard stand (block 1104). A first clamping mechanism is tightened to releasably couple the first foot tube to the foot pedal support assembly (block 1106). A second clamping mechanism is tightened to releasably couple the second foot tube to the foot pedal support assembly (block 1108). A pedal support plate is positioned along the foot pedal support assembly at a desired location, and a foot pedal is coupled to the pedal support plate (block 1110). When disassembly is desired, the pedal is decoupled from the pedal support plate (block 1112) and the first and second clamping mechanisms are released (block 1114).

Stated differently, a method 1100 is provided. The method may be for securing a foot pedal for a musical instrument. The method may include providing a stand for the musical instrument, the stand having a first foot tube and a second foot tube separated by a distance. The method may include adjusting a width of a foot pedal assembly to correspond to the distance (block 1102). The method may include releasably coupling the foot pedal support assembly to the first foot tube via a first clamp (block 1106). The method may include releasably coupling the foot pedal support assembly to the second foot tube via a second clamp (block 1108). The method may include releasably coupling the foot pedal to the foot pedal support assembly (block 1114). One or more of the other blocks illustrated in FIG. 11 may be omitted.

With different features of an assembly now introduced, it is helpful to discuss a few example embodiments of the assembly. Referring to the complete set of diagrams in FIGS. 1A through 10, a clamping mechanism is disclosed. The mechanism may include a clamp finger 140. The mechanism may include a knob 144. The clamp finger 140 may be coupled to a main body 105 and pivotable with respect thereto about a pin 146. The clamp finger 140 may have a conically tapered depression 141. The knob 144 may be engaged with the clamp finger 140 via a bolt 142. The knob 144 may include rounded lower surface. The knob 144 may be rotated about the bolt 142. In connection with the rotating, the rounded lower surface of the knob 144 engages at least a portion of the conically tapered depression 141 to cause the clamp finger 140 to pivot about the pin 146 in a first direction to exert a clamping force.

The clamping mechanism may have one or more other aspects as well. For instance, the clamping mechanism may include a torsion spring 148 disposed about the pin 146 and resisting the pivoting in the first direction. The clamp finger 140 may bound a notched portion of the main body 105 configured to receive a foot tube 202 of a keyboard stand 2 and may exert the clamping force against the foot tube 202 to retain the main body 105 in contact with the foot tube 202.

A foot pedal support assembly is provided. The assembly may include a telescoping main body 105. The assembly may include a slider and a support plate coupled to the main body 105 and configured to support a foot pedal 204. The assembly may include a pair of clamps coupled to the main body 105. Each of the pair of clamps may be configured to releasably couple to a foot tube 202 of a keyboard stand 2.

In various embodiments, the foot pedal support assembly includes one or more further aspects. The telescoping main body 105 may include an inner body 120 and an outer body 110. The inner body 120 may be telescopically receivable into the outer body 110. A first clamp of the pair of clamps may be coupled to an end of the inner body 120. A second clamp of the pair of clamps may be coupled to an end of the outer body 110. The first clamp and second clamp may be positionable at different distances away from each other by telescoping the main body 105.

The pair of clamps may include a first clamp and a second clamp. The first clamp and second clamp may be spaced apart along the main body 105. The first clamp may include a clamp finger 140 coupled to the main body 105 and pivotable with respect thereto about a pin 146. The clamp finger 140 may include a conically tapered depression 141. The first clamp may include a knob 144 engaged with the clamp finger 140 via a bolt 142. The knob 144 may include a rounded lower surface. The rounded lower surface of the knob 144 may engage at least a portion of the conically tapered depression 141 to cause the clamp finger 140 to pivot about the pin 146 in a first direction to exert a clamping force.

The clamp finger 140 may abut the foot tube 202 of the keyboard stand 2 and may exert the clamping force against the foot tube 202. The second clamp may be identical to the first clamp and disposed at an opposite end of the main body 105 relative to the first clamp.

In various instances, the pair of clamps includes a first clamp and a second clamp wherein the first clamp and second clamp are spaced apart along the main body 105. The first clamp may include a first clamp finger 140 coupled to the main body 105 and pivotable with respect thereto about a first pin 146. The first clamp finger 140 may include a first conically tapered depression 141. The first clamp may include a first knob 144 engaged with the first clamp finger 140 via a first bolt 142, wherein the first knob 144 has a first rounded lower surface. The first rounded lower surface of the first knob 144 may engage at least a portion of the first conically tapered depression 141 to cause the first clamp finger 140 to pivot about the first pin 146 in a first direction to exert a clamping force. The second clamp may include a second clamp finger 140 coupled to the main body 105 and pivotable with respect thereto about a second pin 146. The second clamp finger 140 may include a second conically tapered depression 141. The second clamp may include a second knob 144 engaged with the second clamp finger 140 via a second bolt 142. The second knob 144 may include a second rounded lower surface. The second rounded lower surface of the second knob 144 may engage at least a portion of the second conically tapered depression 141 to cause the second clamp finger 140 to pivot about the second pin 146 in a second direction to exert a clamping force.

In various instances, the telescoping main body 105 includes an inner body 120 and an outer body 110. The inner body 120 is telescopically receivable into the outer body 110. A first clamp of the pair of clamps is coupled to an end of the inner body 120. A second clamp of the pair of clamps is coupled to an end of the outer body 110.

A pedal support plate 135 may be attachable to the outer body 110 of the main body 105 along a length of the main body 105 between the first clamp and the second clamp. The pedal support plate 135 may extend perpendicular to the length of the main body 105. A foot pedal 204 may be attached to the pedal support plate 135.

A bracket 130 may be attachable to the outer body 110 of the main body 105 along a length of the main body 105 between the first clamp and the second clamp. The bracket 130 may slidably attach to a pedal support plate 135 extending away from the main body 105 perpendicularly to the length of the main body 105. The pedal support plate 135 may slide along the bracket 130 in a direction normal to a surface 11 of the outer body 110 of the main body 105 (e.g., vertical direction 10). The bracket 130 may be slidable along the length of the main body 105. The bracket 130 may have an adjustment flange 131 extending outwardly from the bracket 130. The bracket 130 may bend in response to application of an external force on the adjustment flange 131 to selectably loosen attachment of the bracket 130 to the main body 105.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled.” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A clamping mechanism comprising:
a clamp finger coupled to a main body and pivotable with respect thereto about a pin, wherein the clamp finger comprises a conically tapered depression; and
a knob engaged with the clamp finger via a bolt, wherein the knob comprises a rounded lower surface,
wherein, when the knob is rotated about the bolt, the rounded lower surface of the knob engages at least a portion of the conically tapered depression to cause the clamp finger to pivot about the pin in a first direction to exert a clamping force.

2. The clamping mechanism of claim 1, further comprising a torsion spring disposed about the pin and resisting the pivoting in the first direction.

3. The clamping mechanism of claim 1, wherein the clamp finger bounds a notched portion of the main body configured to receive a foot tube of a keyboard stand and exert the clamping force against the foot tube to retain the main body in contact with the foot tube.

4. A foot pedal support assembly, comprising:
a telescoping main body;
a slider and a support plate coupled to the main body and configured to support a foot pedal; and
a pair of clamps coupled to the main body, each of the pair of clamps configured to releasably couple to a foot tube of a keyboard stand.

5. The foot pedal support assembly of claim 4, wherein the telescoping main body comprises an inner body and an outer body, wherein the inner body is telescopically receivable into the outer body, wherein a first clamp of the pair of clamps is coupled to an end of the inner body, and wherein a second clamp of the pair of clamps is coupled to an end of the outer body.

6. The foot pedal support assembly of claim 5, wherein the first clamp and the second clamp are positionable at different distances away from each other by telescoping the main body.

7. The foot pedal support assembly of claim 4, wherein the pair of clamps comprises a first clamp and a second clamp, wherein the first clamp and the second clamp are spaced apart along the main body, wherein the first clamp comprises:
a clamp finger coupled to the main body and pivotable with respect thereto about a pin, wherein the clamp finger comprises a conically tapered depression; and
a knob engaged with the clamp finger via a bolt, wherein the knob comprises a rounded lower surface,
wherein, the rounded lower surface of the knob engages at least a portion of the conically tapered depression to cause the clamp finger to pivot about the pin in a first direction to exert a clamping force.

8. The foot pedal support assembly of claim 7, wherein the clamp finger abuts the foot tube of the keyboard stand and exerts the clamping force against the foot tube.

9. The foot pedal support assembly of claim 7, wherein the second clamp is identical to the first clamp and disposed at an opposite end of the main body relative to the first clamp.

10. The foot pedal support assembly of claim 4, wherein the pair of clamps comprises a first clamp and a second clamp, wherein the first clamp and the second clamp are spaced apart along the main body,
wherein the first clamp comprises:
a first clamp finger coupled to the main body and pivotable with respect thereto about a first pin, wherein the first clamp finger comprises a first conically tapered depression; and
a first knob engaged with the first clamp finger via a first bolt, wherein the first knob comprises a first rounded lower surface,
wherein the first rounded lower surface of the first knob engages at least a portion of the first conically tapered depression to cause the first clamp finger to pivot about the first pin in a first direction to exert a clamping force, wherein the second clamp comprises:
a second clamp finger coupled to the main body and pivotable with respect thereto about a second pin, wherein the second clamp finger comprises a second conically tapered depression; and
a second knob engaged with the second clamp finger via a second bolt, wherein the second knob comprises a second rounded lower surface,
wherein the second rounded lower surface of the second knob engages at least a portion of the second conically tapered depression to cause the second clamp finger to pivot about the second pin in a second direction to exert a clamping force.

11. The foot pedal support assembly of claim 10, wherein the telescoping main body comprises an inner body and an outer body, wherein the inner body is telescopically receivable into the outer body, wherein the first clamp of the pair of clamps is coupled to an end of the inner body, and wherein the second clamp of the pair of clamps is coupled to an end of the outer body.

12. The foot pedal support assembly of claim 11, wherein a pedal support plate is attachable to the outer body of the main body along a length of the main body between the first clamp and the second clamp.

13. The foot pedal support assembly of claim 12, wherein the pedal support plate extends perpendicular to the length of the main body.

14. The foot pedal support assembly of claim 13, further comprising the foot pedal attached to the pedal support plate.

15. The foot pedal support assembly of claim 11, further comprising a bracket attachable to the outer body of the main body along a length of the main body between the first clamp and the second clamp, wherein the bracket slidably attaches to a pedal support plate extending away from the main body perpendicularly to the length of the main body.

16. The foot pedal support assembly of claim 15, wherein the pedal support plate slides along the bracket in a direction normal to a surface of the outer body of the main body.

17. The foot pedal support assembly of claim 16, wherein the bracket is slidable along the length of the main body.

18. The foot pedal support assembly of claim 17, wherein the bracket comprises an adjustment flange extending outwardly from the bracket.

19. The foot pedal support assembly of claim 18, wherein the bracket bends in response to application of an external force on the adjustment flange to selectably loosen attachment of the bracket to the main body.

20. A method for securing a foot pedal for a musical instrument, the method comprising:
providing a stand for the musical instrument, the stand having a first foot tube and a second foot tube separated by a distance;
adjusting a width of a foot pedal support assembly to correspond to the distance;
releasably coupling the foot pedal support assembly to the first foot tube via a first clamp;
releasably coupling the foot pedal support assembly to the second foot tube via a second clamp; and
releasably coupling the foot pedal to the foot pedal support assembly.
